(19) United States
(12) Patent Application Publication
(10) Pub. No.: US 2006/0200603 A1
(43) Pub. Date: Sep. 7, 2006

(54) Dynamic resource allocation for a reconfigurable IC

(76) Inventor: Naoto Kaneko, Tokyo (JP)

Correspondence Address: ROBERT M BAUER, ESQ.;LACKENBACH SIEGEL, LLP, 1 CHASE ROAD, SCARSDALE, NY, 10583, US

(21) Appl. No.: 11/068,726

(22) Filed: Mar. 1, 2005

(51) Int. Cl. G06F 13/00

(52) U.S. Cl. 710/104

(57) ABSTRACT

A data modifier for formatting configuration data for configuring a reconfigurable integrated circuit having access to addressable resources, the data modifier comprising a data receiver for receiving first configuration data of a first form defining a configuration of the integrated circuit for performing operations on the addressable resources, the first configuration data referring to the addressable resources by means of symbolised references and a data fomatter for forming second configuration data based on the first configuration data by replacing each symbolised reference with an absolute reference to a respective one of the addressable resources.

The present invention relates to a method of dynamically allocating resources in a programmable IC (integrated circuit). Specifically, the present invention relates to a Dynamically Reconfigurable Hardware (DRHW), in which configuration data is allocated configuration plane and memory resources on a dynamic basis.

Dynamically Reconfigurable Hardware (DRHW) is a class of programmable IC. Programmable ICs are more flexible than application specific integrated circuits (ASICs), which have a hard-wired layout that is designed for performing specific, predefined functions. In contrast, programmable ICs are reconfigurable and can therefore be adapted for performing a wide variety of different functions.

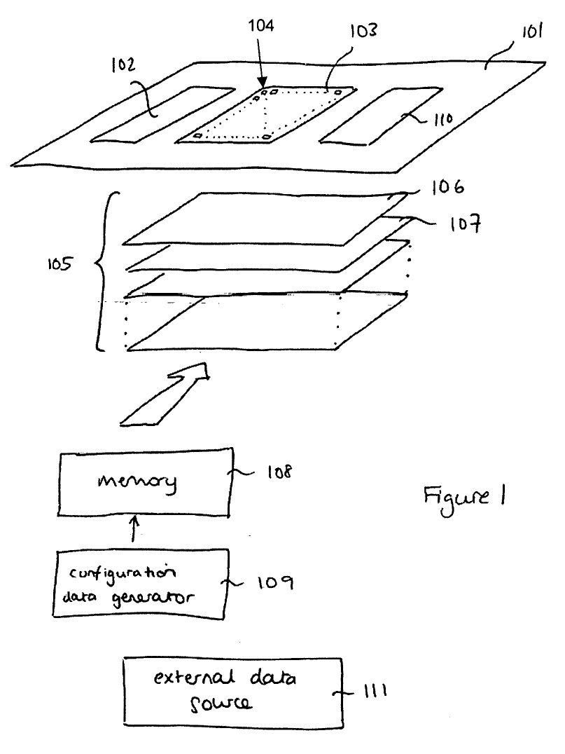

FIG. 1 illustrates a typical DRHW, shown generally at 101. The DRHW consists of an array of logic elements 104 and a routing network 103. The connections between the logic elements are formed via the routing network, which might be an array of switches. The configuration of the logic elements in the DRHW is therefore not permanent, created by hardwired connections, but can be changed to enable the DRHW to perform different functions. Thus, although the logic array of the DRHW is implemented in hardware, it can essentially be programmed by configuration data stored on configuration planes 105.

The DRHW has a rich on-chip embedded memory 102 and an on-chip program memory 110. These memories night typically be implemented as static random access memory (SRAM). The program memory is used to hold configuration data for the array of logic elements and the routing network. Configuration data is the binary code that defines how each logic element and routing switch of the DRHW behaves. A particular configuration of the routing network is achieved by writing the appropriate configuration data into the program memory.

The DRHW usually has multiple sets of configuration data stored on-chip in a configuration memory. Each set of configuration data is called a configuration plane (shown schematically at 105 in FIG. 1) and defines a particular configuration of the routing network. The DRHW can typically hold configuration data corresponding to multiple different functions.

Each configuration plane may define a configuration of the logic array that performs multiple functions, a single function or part of a function. If a configuration plane defines the configuration for only part of a function, then the configuration data for performing the remaining part of that function can be arranged on a different configuration plane. Therefore, in order for the DRHW to complete a function, it may be necessary for the configuration plane for a first part of the function to be loaded first into the program memory, followed by the configuration plane for the next part of the function. For example, function fₙ(A) may be located on configuration planes 106 and 107. Therefore, in order for the DRHW to complete function fₙ(A), configuration plane 106 would be written to the program memory 110 first, followed by configuration plane 107.

It is a particularly advantageous feature of the DRHW that the logic array may be reconfigured on a cycle-by-cycle basis. This allows on-demand execution of a function similar to a process call in an operating system.

Given that a single configuration plane may define a configuration for multiple independent functions, it is important that each of the functions is assigned a specific area of the on-chip memory so that a function does not read or write to memory locations being used by another function. Similarly, it is important that the configuration plane corresponding to each of the functions is known, so that, for example, in the situation described above, it is known which of the configuration planes should be loaded next in order to complete a specific function (e.g. configuration planes 106 and 107 for function fₙ(A)). This allocation of resources is conventionally done in a fixed manner when the configuration data is generated. So for example, in FIG. 1, the configuration data generator 109 allocates the memory and configuration plane resources to be accessed by the configuration data when it generates that data. Therefore, it can be seen that the function of the configuration data generator is similar to a compiler.

Although the DRHW can store multiple configuration planes in its configuration memory, it is preferable for it to be able to access additional configuration data. It would be inconvenient and limit the potential usefulness of the DRHW if it were limited to the configuration data stored in its configuration memory. A DRHW that was limited to the configuration data contained in its configuration memory can be likened to a personal computer that only allows users to execute a pre-installed set of programs. Therefore, in addition to switching between configuration planes stored in the on-chip configuration memory 110, the DRHW may also download new sets of configuration data. For example, in FIG. 1 the DRHW has an additional off-chip memory 108. The DRHW may also have access to an external data source 111, e.g. via a wired or wireless network. The downloading of external data may be triggered by a user-preference or environmental profile associated with the device that contains the DRHW.

Although it is preferable for the DRHW to have access to additional data for reconfiguring the logic array, this is problematic because of the necessity for allocating specific resources of the DRHW when the configuration data is generated. For example, the functions defined by the configuration data must be allocated a configuration plane and memory resources, as described above. However, the configuration data generator needs to have a complete knowledge of the other functions that will be contained in the configuration memory of the DRHW at the same time, if it is to be able to allocate resources to a particular function. This is not possible when the configuration data generator is generating configuration data that may not be loaded into the configuration memory for some time.

Previously, if the new data required a recombination of a DRHW function, all of the associated configuration data had to be recompiled. However, this is time consuming and removes the DRHW's advantage of reconfiguration on a cycle-by-cycle basis. This has not been a problem up to now because the dynamic loading of data for configuring a DRHW has not been brought into practice. However, if the technology is to be exploited to its full potential, it is necessary to find a way to deal with the issue of resource allocation for dynamic loading of data on a DRHW.

Therefore, there is a need for a dynamic method for allocating resources in a DRHW.

According to one embodiment of the present invention, there is provided a data modifier for formatting configuration data for configuring a reconfigurable integrated circuit having access to addressable resources, the data modifier comprising a data receiver for receiving first configuration data of a first form defining a configuration of the integrated circuit for performing operations on the addressable resources, the first configuration data referring to the addressable resources by means of symbolised references and a data formatter for forming second configuration data based on the first configuration data by replacing each symbolised reference with an absolute reference to a respective one of the addressable resources.

Preferably, the data modifier comprises a memory for storing a resolution table identifying for each symbolised reference the respective one of the addressable resources, and preferably the data formatter is arranged to replace each symbolised reference in the first configuration data in accordance with the content of the resolution table.

The resources may include working memory locations. The resources may include memory locations for storing one or more sets of second configuration data. The data modifier preferably comprises a data store for storing the second configuration data in the said memory locations.

The configuration data may be for configuring a dynamically reconfigurable hardware unit and the integrated circuit may be a dynamically reconfigurable hardware unit.

The data formatter is preferably arranged to form the second configuration data by the steps of analysing the first configuration data to identify symbolised references to resources therein, establishing a mapping between each identified symbolised reference and a respective absolute reference to a respective one of the addressable resources, storing the established mappings in the resolution table and replacing each symbolised reference with an absolute reference to a respective one of the addressable resources.

The first configuration data preferably comprises a data block listing the symbolised references in the first configuration data and the step of analysing the first configuration data preferably comprises reading the data from the data block.

The step of establishing a mapping preferably comprises determining for each of the identified symbolised references one of the addressable resources that is currently available for allocation and allocating it by mapping its absolute reference to the respective symbolised reference.

At least one of the addressable resources may be addressable by means of the integrated circuit when configured according to the second configuration data by way of a reference to the resource through an address resolution system.

At least one of the addressable resources may be addressable by means of the integrated circuit when configured according to the second configuration data by way of a configured connection in the integrated circuit to the resource.

According to a second embodiment of the present invention, there is provided a method for formatting configuration data for configuring a reconfigurable integrated circuit having access to addressable resources, the method comprising receiving first configuration data of a first form defining a configuration of the integrated circuit for performing operations on the addressable resources, the first configuration data referring to the addressable resources by means of symbolised references and forming second configuration data based on the first configuration data by replacing each symbolised reference with an absolute reference to a respective one of the addressable resources.

The present invention will now be described by way of example with reference to the accompanying drawings in which:

FIG. 1 shows a Dynamically Reconfigurable Hardware (DRHW);

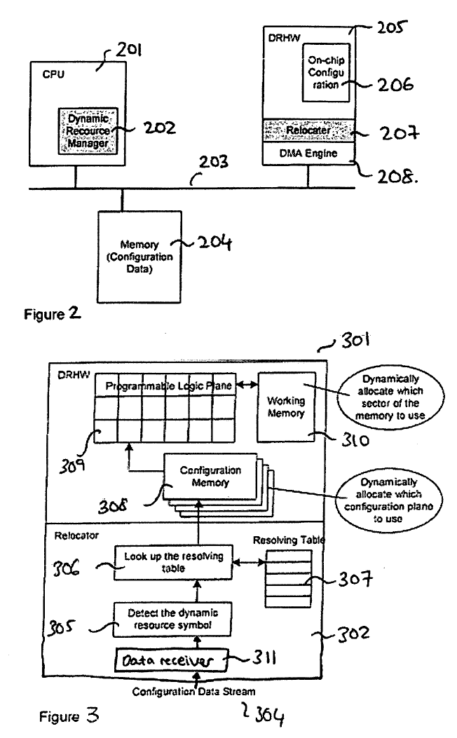

FIG. 2 shows an arrangement for implementing a method of dynamically allocating memory and configuration plane resources;

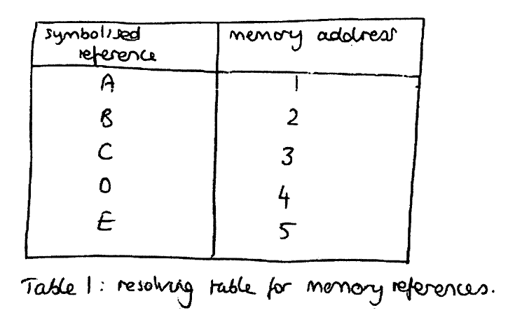

FIG. 3 shows a functional representation of the DRHW according to an embodiment of the present invention; and

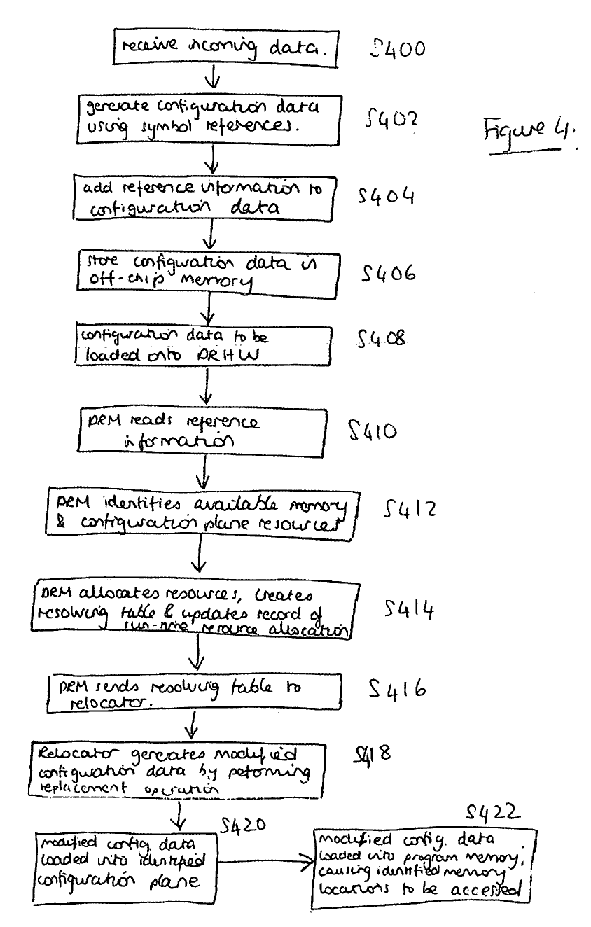

FIG. 4 shows a flow diagram illustrating a method of dynamically allocating memory and configuration plane resources.

Embodiments of the present invention provide a method for dynamically allocating resources in a DRHW, in which the allocation of resources is postponed until the configuration data is loaded into the DRHW. This is achieved by leaving the resource allocation undecided during configuration data generation and only making the required resource allocations when the configuration data is loaded into the configuration memory of the DRHW. In this way, when the resources are allocated to a particular function, the configuration plane and memory resources being used by the other functions in the configuration memory are known and so the new function being loaded can be allocated resources accordingly.

This method of dynamically allocating resources may be achieved by means of the following: a configuration data generator that supports symbolisation of references to memory and configuration plane allocations; a dynamic resource manager that keeps track of memory and configuration plane allocations in the DRHW and an “on-the-fly” configuration data modifier at the configuration data input port of the DRHW.

FIG. 2 illustrates an arrangement suitable for implementing the method of dynamic resource allocation. The arrangement comprises a central processing unit (CPU) 201, a configuration data memory 204 and a DRHW 205. The CPU contains a dynamic resource manager (DRM) 202. The DRM is implemented as software on the CPU and may operate e.g. in a similar fashion to the UNIX malloc( ) function. The DRHW contains a direct memory access driver (DMA) 208, a configuration data modifier or relocator 207 and an on-chip configuration memory 206. The CPU 201, configuration data memory 204 and DRHW 205 are connected via a shared bus 203.

The configuration data generator, which is not illustrated in FIG. 1, is arranged to use symbols instead of specific references to memory and configuration plane allocations in the generated configuration data. The configuration data generator then adds a summary of the symbols used to the configuration data. The generated configuration data is then loaded into the off-chip memory 204, from which it can be loaded into DRHW 205 when required.

Configuration data may be transferred to the DRHW 205 by the DMA 208 and via the bus 203 when required. At this point, the configuration data still contains the symbolised resource references. The configuration data cannot be loaded into the on-chip configuration memory 206 until these symbolised resource references have been resolved. This is achieved by means of the relocator 207, using information from the DRM 202.

The DRM keeps track of resource allocation. When configuration data is loaded from the configuration data memory 204 to the DRHW 205, the DRM reads the resource usage information embedded in the configuration data i.e. the summary added to the configuration data by the configuration data generator. The embedded information includes a list of symbols used in the configuration data and may also include additional information, such as required memory size for symbols that refer to memory resources. The DRM has access to the record of run-time resource allocation. Therefore, the DRM knows which resources have been allocated to the configuration data already held on the DRHW. The DRM uses this information to allocate available resources to the loading configuration data by producing a resolving table. The resolving table matches symbols in the loading configuration data with specific codes for an allocated resource. So for example, in table 1, which shows a very simple resolving table, a symbolised reference ‘B’ has been allocated to memory location ‘2’ by the DRM.

The DRM sends the resolving table for the loading configuration data to the relocator. The relocator then uses the resolving table to replace symbolised resource references in the configuration data with the appropriate specific codes. Once the relocator has replaced all of the symbolised references contained in the configuration data, the configuration data is able to be loaded onto the specific configuration plane referenced in the data. Similarly, when the configuration data loaded into the on-chip configuration memory is written to the on-chip program memory of the DRHW, the memory locations referenced by the specific codes contained in the configuration data will be accessed. In this way, specific resources are allocated to the configuration data in a dynamic fashion, as the specific resource allocations are postponed until the data is actually loaded into the DRHW, at which point it is known which resources are available to be allocated.

Although the method according to embodiments of the present invention has been described specifically in relation to allocating memory and configuration plane resources, it should be understood that this is for the purposes of example only. The method of dynamically allocating resources according to embodiments of the present invention can be used for allocating any suitable resources in a programmable IC.

The DRHW is shown in more detail in FIG. 3. The relocator 302 receives the incoming configuration data stream 304 at the data receiver 311 via the bus 203. The relocator then detects the symbolised references in the incoming configuration data stream (305) and uses the resolving table 307 received from the DRM to look-up the symbolised references and replace them with the specific codes contained in the resolving table. The relocator 302 is therefore a data modifier comprising a data receiver 311 and a data formatter 305-307. The modified configuration data is then loaded into the configuration memory 308 in the appropriate configuration plane. When a specific configuration plane is written to the on-chip program memory of the DRHW (which is not shown in FIG. 3), the arrangement of the programmable logic plane 309 is defined by that configuration plane. The DRHW then proceeds to operate with the reconfigured programmable logic plane and to access the specific addresses of the on-chip embedded memory 310 that are contained in the modified configuration data.

The relocator 302 may be implemented in hardware at the configuration data input of the DRHW. For example, the relocator may consist of a comparator and the resolving table. Alternatively, the relocator need not be located in the DRHW, e.g. it could be located in the CPU. The relocator could also be implemented in software.

A method of dynamically allocating resources according to an embodiment of the present invention is illustrated in FIG. 4. In step S400, the device receives incoming function data. In step S402, the configuration data generator generates the required configuration data from the function data. As explained above, the configuration data generator generates the binary code that defines how each logic element and routing switch of the DRHW behaves. When generating the configuration data in step S402, the configuration data generator uses symbols to refer to resource allocations such as configuration plane and memory allocations. In step S404, the configuration data generator completes the data generation procedure by adding a summary containing the list of symbols used for resource references and any additional required information to the configuration data. The configuration data may then be loaded into the off-chip memory in step S406. In step S408, the configuration data is to be loaded from the memory into the DRHW. In step S410, the DRM reads the embedded information in the configuration data to be loaded. In step S412, the DRM identifies the configuration plane and memory resources that are available from its record of run-time resource allocation. In step S414, the DRM allocates configuration and memory plane resources to the configuration data and creates a resolving table showing the mapping between the symbols of the configuration data and the specific codes of the allocated resources. The DRM also updates the record of run-time resource allocation to take account of the new allocations. In step S416, the DRM sends the resolving table to the relocator. In step S418, the relocator uses the resolving table received from the DRM to perform a replacement operation on the incoming configuration data, so that the symbols references contained in the configuration data are replaced by the specific codes contained in the resolving table. In step S420, the modified configuration data is loaded into a configuration plane of the configuration memory of the DRHW. The configuration plane is identified by a specific code in the modified configuration data. In step S422, the modified configuration data is written to the on-chip program memory of the DRHW, thereby causing the memory locations identified in the modified configuration data to be accessed.

In addition to loading new configuration data into the configuration memory of the DRHW, it may also be necessary for existing configuration data held in the configuration memory to be replaced, in order to make room for incoming data. Therefore, the DRM may also operate as a memory manager for determining when currently allocated resources may be reallocated to new configuration data. Alternatively, a separate entity, which may or may not be contained in the CPU, may be responsible for managing the configuration memory of the DRHW.

A simple way for replacing existing data in the configuration memory of the DRHW is by altering the record of ruin-time resource allocation, so that the resources allocated to the existing data (e.g. configuration plane and working memory allocations) appear to be available to the DRM. The existing data is therefore replaced in the configuration memory of the DRHW when those resources are reallocated. In this situation, the memory manager might beneficially be the entity that maintains the record of run-time resource allocation. Alternatively, the DRM may have access to both a record of run-time resource allocation (that shows all currently allocated resources) and information about which of those allocated resources may be reallocated. The information about which resources may be reallocated may be generated by the DRM itself, if it is acting as the memory manager, or by a different entity.

The replacement of data in the configuration memory of the DRHW may be organised according to any well-known memory management scheme. For example, the configuration memory of the DRHW is similar to a cache of the off-chip memory and may be managed according to any well-known cache replacement strategy, e.g. fetch-and-discard, least-recently-used etc. However, unlike a conventional cache, the configuration data held in the configuration memory is preferably not written back when it is replaced. The configuration data stored in the configuration memory is the modified configuration data that contains the specific resource references. Therefore, as the specific resource references are allocated on a dynamic basis, they are valid only for the specific time when that configuration data was modified. The configuration data stored in the off-chip memory should always contain the symbolised resource references, in order that the specific resources may be allocated on a dynamic basis.

Although the description above and FIGS. 2 and 4 refer to the configuration data being stored on a memory and subsequently being loaded onto the DRHW (see e.g. step S406 of FIG. 4), the data may actually be loaded directly into the DRHW from an external source. Data received from an external source may either be in the format of configuration data (as described below) or may be in a different format, which a configuration data generator in the device will convert into configuration data.

The description above has mainly described a device that has a DRHW and a configuration data generator (see e.g. FIG. 1). However, the method for dynamically allocating resources according to embodiments of the present invention may be also be implemented by a device without a configuration data generator and which receives configuration data directly from an external source, as stated above. For example, the configuration data may be received via a wired or wireless connection from another device. Provided that the configuration data received by the device is binary code that defines how each logic element and routing switch of the DRHW behaves, and which contains the required symbolised resource references and embedded resource information, the relocator of the DRHW, together with the DRM, will generate the modified configuration data required.

The resources such as memory blocks or locations that are to be addressed by the DRHW may be addressed in a number of ways. First, they may be addressed by way of a reference to the resource through an address resolution system such as the router of a bus or the access control system of a memory chip. Second, they may be addressed by way of a configured hardwired connection to the resource when the DRHW is configured according to a set of configuration data.

Embodiments of the present invention may advantageously be implemented in mobile phone networks. For example, the DRHW may be contained within a mobile phone and the mobile phone may receive data defining functions of the mobile phone to be implemented by the DRHW from the wireless communications network e.g. modulation. Therefore, the mobile station need not be prearranged to operate according to a particular telecommunications standard, but may download the necessary functional information for the network within which it is currently operating. For example, if the mobile station moves from a cell operating according to the GSM standard into a cell operating according to the UMTS standard, the mobile phone can download the functional information necessary to operate in accordance with the UMTS standard from its new cell. That functional information can then be used to configure the DRHW as required.

A device may contain more than one DRHW.

Although the specific example given above relates to mobile phones and telecommunications networks, it should be understood that the present invention is not limited to any specific implementation. The present invention is applicable to any practical situations in which a programmable IC may be used.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

1. A data modifier for formatting configuration data for configuring a reconfigurable integrated circuit having access to addressable resources, the data modifier comprising:
a data receiver for receiving first configuration data of a first form defining a configuration of the integrated circuit for performing operations on the addressable resources, the first configuration data referring to the addressable resources by means of symbolised references; and
a data formatter for forming second configuration data based on the first configuration data by replacing each symbolised reference with an absolute reference to a respective one of the addressable resources.

2. A data modifier as claimed in claim 1, comprising a memory for storing a resolution table identifying for each symbolised reference the respective one of the addressable resources, and wherein the data formatter is arranged to replace each symbolised reference in the first configuration data in accordance with the content of the resolution table.

3. A data modifier as claimed in claim 1 or 2, wherein the resources include working memory locations.

4. A data modifier as claimed in any preceding claim, wherein the resources include memory locations for storing one or more sets of second configuration data.

5. A data modifier as claimed in claim 4, wherein the data modifier comprises a data store for storing the second configuration data in the said memory locations.

6. A data modifier as claimed in any preceding claim, wherein the configuration data is for configuring a dynamically reconfigurable hardware unit.

7. A data modifier as claimed in claim 6, wherein the integrated circuit is a dynamically reconfigurable hardware unit.

8. A data modifier as claimed in claim 2 or any preceding claim as dependent on claim 2, wherein the data formatter is arranged to form the second configuration data by the steps of:
analysing the first configuration data to identify symbolised references to resources therein;
establishing a mapping between each identified symbolised reference and a respective absolute reference to a respective one of the addressable resources;
storing the established mappings in the resolution table; and
replacing each symbolised reference with an absolute reference to a respective one of the addressable resources.

9. A data modifier as claimed in claim 8, wherein the first configuration data comprises a data block listing the symbolised references in the first configuration data and the step of analysing the first configuration data comprises reading the data from the data block.

10. A data modifier as claimed in claim 8 or 9, wherein the step of establishing a mapping comprises determining for each of the identified symbolised references one of the addressable resources that is currently available for allocation and allocating it by mapping its absolute reference to the respective symbolised reference.

11. A data modifier as claimed in any preceding claim, wherein at least one of the addressable resources is addressable by means of the integrated circuit when configured according to the second configuration data by way of a reference to the resource through an address resolution system.

12. A data modifier as claimed in any preceding claim, wherein at least one of the addressable resources is addressable by means of the integrated circuit when configured according to the second configuration data by way of a configured connection in the integrated circuit to the resource.

13. A method for formatting configuration data for configuring a reconfigurable integrated circuit having access to addressable resources, the method comprising:
receiving first configuration data of a first form defining a configuration of the integrated circuit for performing operations on the addressable resources, the first configuration data referring to the addressable resources by means of symbolised references; and
forming second configuration data based on the first configuration data by replacing each symbolised reference with an absolute reference to a respective one of the addressable resources.
